(19) United States
(12) Patent Application Publication
(10) Pub. No.: US 2013/0260075 A1
(43) Pub. Date: Oct. 3, 2013

(54) Method for Producing Molded Elements Comprising Photoluminescent and/or Night Luminous Particles, a Molded Element and Composite Plate Made of a Plurality of Molded Elements

(71) Applicants: Gerhard Dust, Gummersbach (DE); Michael Plötner, Wolfsberg OT Bucheloh (DE)

(72) Inventors: Gerhard Dust, Gummersbach (DE); Michael Plötner, Wolfsberg OT Bucheloh (DE)

(73) Assignee: POLYCARE RESEARCH TECHNOLOGY GMBH & CO. KG, Gehlberg (DE)

(21) Appl. No.: 13/994,647

(22) PCT Filed: Dec. 13, 2011
(86) PCT No.: PCT/EP11/72625

§ 371 Date: Jun. 14, 2013

(30) Foreign Application Priority Data
Dec. 14, 2010 (DE) 10 2010 063 000.4

(51) Int. Cl. E01C 9/00; B29C 39/10; B29C 39/02

(52) U.S. Cl. CPC E01C 9/00; B29C 39/025; B29C 39/10
USPC 428/51; 264/21; 428/690; 428/47

(57) ABSTRACT

The invention relates to a method for producing molded elements (1) comprising photoluminescent and/or night luminous particles (6). According to the invention, the molded elements (1) are formed of polymer concrete, in the base layer (3) of which photoluminescent and/or night luminous particles (6) and/or further particles (7) are introduced, the base layer being covered and protected by a surface layer (2). The invention further relates to a molded element (1) comprising photoluminescent and/or night luminous particles (6) and an assembly comprising a plurality of molded elements (1).

The invention relates to a method for producing molded elements comprising photoluminescent and/or noctilucent particles as per the preamble of claim 1. Furthermore, the invention relates to a molded element comprising photoluminescent and/or noctilucent particles as per the preamble of claim 9. Furthermore, the invention relates to an assembly consisting of a plurality of molded elements comprising photoluminescent and/or noctilucent particles as per the preamble of claim 10.

DE 10 2008 004 165 relates to a molded brick having afterglow properties. In order to make a simple and permanent possibility for afterglow paving slabs available, provision is made in this document to admix photoluminescent luminescent pigments to the components and additives which are common for producing concrete.

The invention is based on the object of specifying a method for producing molded elements comprising photoluminescent and/or noctilucent particles which is improved and in particular more cost-effective compared to the prior art, a molded element comprising photoluminescent and/or noctilucent particles and an assembly consisting of a plurality of molded elements, where in particular a surface quality and a chemical and/or mechanical resistance of the molded element are significantly improved.

In terms of the method, the object is achieved according to the invention by the features indicated in claim 1. In terms of the molded element, the object is achieved by the features indicated in claim 9. In terms of the assembly, the object is achieved by the features indicated in claim 10.

Advantageous configurations of the invention are the subject matter of the dependent claims.

In the method for producing molded elements comprising photoluminescent and/or noctilucent particles, the molded elements are formed from polymer concrete, into the base layer of which, which is covered and protected by a surface layer, photoluminescent and/or noctilucent particles and/or further particles are introduced. This makes it possible to obtain a durable molded element with photoluminescent and/or noctilucent properties, wherein the photoluminescent and/or noctilucent particles are advantageously arranged only in the base layer. An effect which is comparable to that obtained by admixing the luminescent particles into the entire molded element can therefore be achieved with a particularly small quantity of photoluminescent and/or noctilucent particles. It is particularly advantageous that the photoluminescent and/or noctilucent particles are arranged only in the visible regions of the molded element. As a result, the costs for producing the molded element comprising photoluminescent and/or noctilucent particles drop significantly.

In a first method step, a release agent is applied to a casting mold or at least to a surface of the casting mold. As a result, the molded element can be removed from the casting mold in a particularly simple manner.

In a second method step, a colorless gel coat having a high abrasion resistance and/or weathering resistance is introduced mechanically or manually into the casting mold as a surface layer (having a high mechanical and/or chemical resistance). This makes it possible to achieve a surface layer, which encloses or surrounds the molded element in a protective manner, having a particularly high chemical and/or mechanical resistance.

In a third method step, a colorless gel coat is applied to the initially dried surface layer as the base layer of the photoluminescent and/or noctilucent particles, wherein the photoluminescent and/or noctilucent particles and/or further particles are then introduced into the base layer or applied to the base layer and held on and/or in the base layer by adhesive forces. As a result, the photoluminescent and/or noctilucent particles are held in and/or on the base layer without damaging the surface layer. Since the photoluminescent and/or noctilucent particles are embedded into the base layer, the photoluminescent and/or noctilucent particles are therefore employed particularly sparingly. It is particularly advantageous that further particles which can be used to achieve advantageous optical effects and/or patterns can be introduced into the base layer.

In a fourth method step, a colored gel coat can be applied to the initially dried base layer. It is therefore possible to produce molded elements from polymer concrete in all colors.

In a fifth method step, the casting mold is filled with a polymer concrete mixture. This conventional polymer concrete mixture preferably forms the main constituent of the molded element, as a result of which molded elements with photoluminescent and/or noctilucent properties can be produced at particularly low cost.

The photoluminescent and/or noctilucent particles are introduced into the base layer in a uniform distribution, concentrated at points, in the form of characters, letters and/or numbers. All conceivable shapes and/or characters can therefore be formed by means of the photoluminescent and/or noctilucent particles.

Glass fragments, rock fragments and/or colored or dyed sand or sand mixtures can be introduced into the base layer as further particles. This makes it possible to achieve a visually pleasing surface configuration of the molded element which comprises not just the photoluminescent and/or noctilucent particles.

The molded element comprising photoluminescent and/or noctilucent particles is formed from polymer concrete, which on the surface is surrounded or covered by a base layer, which is covered and protected by a surface layer, wherein photoluminescent and/or noctilucent particles and/or further particles can be introduced into the base layer.

In the composite plate consisting of a plurality of molded elements comprising photoluminescent and/or noctilucent particles as claimed in claim 9, the plurality of molded elements are assembled to form a pattern which covers a substantially square area, wherein the individual molded elements are formed as polygonal squares, rectangles and/or polygons and are connected to one another by means of a woven reinforcing fabric arranged in a form-fitting, force-fitting and/or integral manner on the rear side of the molded elements in such a manner that the individual molded elements are arranged spaced apart from one another, wherein outer edges of the composite plate are formed so as to correspond to one another in such a manner that composite plates with different patterns can be arranged in a variable arrangement in relation to one another.

Exemplary embodiments of the invention will be explained in more detail hereinbelow on the basis of drawings, in which:

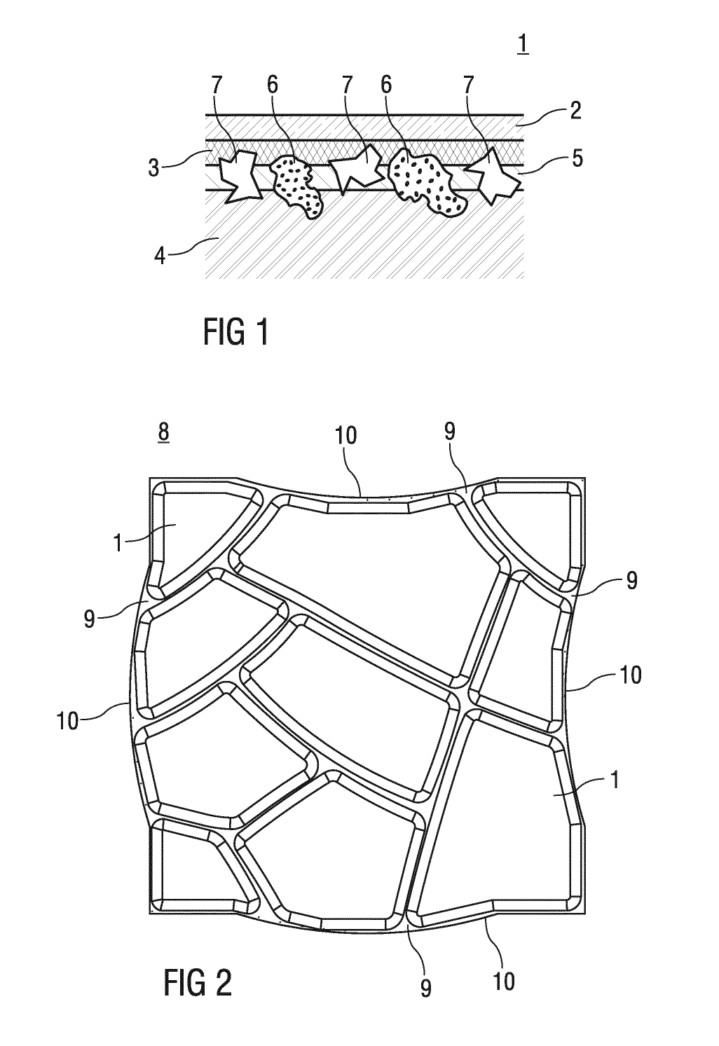

FIG. 1 schematically shows a sectional illustration through a molded element according to the invention, and

FIG. 2 schematically shows a composite plate according to the invention consisting of a plurality of molded elements.

Parts corresponding to one another are provided with the same reference signs in all figures.

FIG. 1 schematically shows a sectional illustration through a molded element 1 according to the invention. The molded element 1 is formed from a plurality of individual layers and comprises at least one surface layer 2, a base layer 3 and a layer 4 of the polymer concrete mixture. Here, the molded element 1 is formed substantially from the layer 4 of the polymer concrete mixture, which is coated on the surface with the surface layer 2 and the base layer 3. This surface coating of the layer 4 of the polymer concrete mixture can in this case enclose the molded element 1 completely, or, in an alternative embodiment, can cover it only partially or in certain portions.

In an alternative embodiment of the invention, an additional color layer 5 can be arranged between the base layer 3 and the layer 4 of the polymer concrete mixture.

The surface layer 2 is a layer of a colorless, conventional gel coat having a layer thickness of preferably 0.8 to 1.0 mm. The surface layer 2 has a particularly high mechanical and/or chemical resistance and, for example, has a particularly high abrasion resistance and weathering resistance.

The base layer 3 is formed from a conventional colorless gel coat, which can have a mechanical and/or chemical resistance which is reduced compared to the surface layer 2. Conventional photoluminescent and/or noctilucent particles 6 are introduced into the base layer 3. In this respect, the photoluminescent and/or noctilucent particles 6 are scattered onto the base layer 3 and can sink thereinto, the photoluminescent and/or noctilucent particles 6 being held on and in the base layer 3 by adhesive forces. The grain size of the photoluminescent and/or noctilucent particles 6 is preferably 3 to 5 mm. The layer thickness of the base layer 3 is preferably 0.8 to 1.0 mm.

In an alternative embodiment, further particles 7 can be embedded into the base layer 3. Here, conventional glass fragments, rock fragments and/or colored or dyed sand or sand mixtures can be embedded into the base layer 3 as further particles 7.

The color layer 5 is formed from a conventional colored or dyed gel coat. The layer 4 is formed from a conventional polymer concrete mixture.

The molded element 1 is shaped as a substantially planar molded element or as a three-dimensionally shaped molded element, for example as a sphere, pyramid, cone or truncated cone.

In an advantageous embodiment, the molded element 1 is shaped as a curbstone, path boundary stone, coping, paving slab or edging stone.

In a further advantageous embodiment, the molded element 1 is shaped as a stepping stone, where the individual stepping stones can be shaped so as to correspond to one another, such that a plurality of stepping stones can be laid together, or the stepping stones can be laid individually at a distance from one another.

In an alternative embodiment, the molded element 1 is formed as a fence post, gate post, stele or pillar or is shaped as an attachment or cover for a fence post, gate post, stele or pillar.

In a further alternative embodiment, the molded element 1 is shaped as a directive and/or indicative element, for example as a signpost, promotional sign, warning sign or direction sign.

In a particularly advantageous embodiment, the molded element 1 is shaped as a composite plate 8. A composite plate 8 of this type comprises a plurality of molded elements 1, which are assembled to form a pattern. This pattern covers a substantially square area. Here, the individual molded elements 1 are formed as polygonal squares, rectangles and/or polygons. The individual molded elements 1 are connected to one another by means of a woven reinforcing fabric 9 arranged in a form-fitting, force-fitting and/or integral manner on the rear side of the molded elements 1. Here, the molded elements 1 are spaced apart from one another on the woven reinforcing fabric 9, so that an intermediate space measuring, for example, 3 to 10 mm is formed between the adjacently arranged molded elements 1. Therefore, the composite plate 8 is permeable to water and a composite plate 8 advantageously does not count as a sealed surface.

The outer edges 10 of the composite plate 8 are formed so as to correspond to one another in such a manner that composite plates 8 with different patterns can be arranged in a variable arrangement in relation to one another.

In a further particularly advantageous embodiment, the composite plates 8 have a different arrangement of the individual molded elements 1 at each outer edge 10, such that, depending on the lateral joining or arrangement of the individual composite plates 8, different or variable overall patterns can be produced. Individual patterns for laying the composite plates 8 are therefore made possible in a particularly advantageous manner.

In the method for producing molded elements 1 comprising photoluminescent and/or noctilucent particles 6, in a first method step, a release agent is applied to a casting mold or at least to a surface of the casting mold. Here, the release agent can be applied manually or can be sprayed on mechanically.

In a second method step, the colorless gel coat having a high abrasion resistance and/or weathering resistance is introduced or applied mechanically or manually into the casting mold as a surface layer 2 having a high mechanical and/or chemical resistance.

In a third method step, the colorless gel coat, which forms the base layer 3 of the photoluminescent and/or noctilucent particles 6 and/or of the further particles 7, is applied or laid onto the initially dried surface layer 2. Then, the photoluminescent and/or noctilucent particles 6 and/or the further particles 7 are scattered into the base layer 3. Here, the photoluminescent and/or noctilucent particles 6 can be introduced into the base layer 3 in a uniform distribution. In an alternative embodiment, the photoluminescent and/or noctilucent particles 6 can be introduced into the base layer 3 concentrated at points, for example in the form of characters, letters and/or numbers.

In a fourth method step, the colored gel coat can be applied or laid as a color layer 5 onto the initially dried base layer 3.

In a fifth method step, the casting mold is filled completely with a polymer concrete mixture. Here, the polymer concrete mixture can be produced by means of a conventional concrete mixing machine or a continuous casting machine. In a particularly advantageous embodiment, light fillers can be added to the polymer concrete mixture, such that a molded element 1 of reduced weight is formed.

In a further, alternative method step, the woven reinforcing fabric 9 can be laid onto the rear side of the polymer concrete mixture for the individual molded elements 1 to form a composite plate 8, such that it sinks into the layer 4 of the polymer concrete mixture in such a manner that it is surrounded completely by the polymer concrete mixture in the region of the individual molded elements 1.

### LIST OF REFERENCE SIGNS

1 Molded element

2 Surface layer

3 Base layer

4 Layer of polymer concrete mixture

5 Color layer

6 Photoluminescent and/or noctilucent particles

7 Particles

8 Composite plate

9 Woven reinforcing fabric

10 Outer edge

1. A method for producing molded elements (1) comprising photoluminescent and/or noctilucent particles (6),
characterized in that the molded elements (1) are formed from polymer concrete, into the base layer (3) of which, which is covered and protected by a surface layer (2), photoluminescent and/or noctilucent particles (6) and/or further particles (7) are introduced.

2. The method as claimed in claim 1,
characterized in that, in a first method step, a release agent is applied to a casting mold or at least to a surface of the casting mold.

3. The method as claimed in claim 1,
characterized in that, in a second method step, a colorless gel coat having a high abrasion resistance and/or weathering resistance is introduced mechanically or manually into the casting mold as a surface layer (1) having a high mechanical and/or chemical resistance.

4. The method as claimed in claim 3,
characterized in that, in a third method step, a colorless gel coat is applied to the initially dried surface layer (2) as the base layer (3) of the photoluminescent and/or noctilucent particles (6), wherein the photoluminescent and/or noctilucent particles (6) and/or further particles (7) are then introduced into the base layer (3) or applied to the base layer (3) and held on and/or in the base layer (3) by adhesive forces.

5. The method as claimed in claim 4,
characterized in that, in a fourth method step, a colored gel coat is applied to the initially dried base layer (3) comprising the photoluminescent and/or noctilucent particles (6) and/or further particles (7).

6. The method as claimed in claim 5,
characterized in that, in a fifth method step, the casting mold is filled with a polymer concrete mixture.

7. The method as claimed in claim 1,
characterized in that the photoluminescent and/or noctilucent particles (6) are introduced into the base layer (3) in a uniform distribution, concentrated at points, in the form of characters, letters and/or numbers.

8. The method as claimed in claim 1,
characterized in that glass fragments, rock fragments and/or colored or dyed sand or sand mixtures are introduced into the base layer (3) as further particles (7).

9. A molded element (1) comprising photoluminescent and/or noctilucent particles (6),
formed from polymer concrete, which on the surface is surrounded or covered by a base layer (3), which is covered and protected by a surface layer (2), wherein photoluminescent and/or noctilucent particles (6) and/or further particles (7) can be introduced into the base layer (3).

10. An assembly consisting of a plurality of molded elements (1) comprising photoluminescent and/or noctilucent particles (6) as claimed in claim 9,
characterized in that the plurality of molded elements (1) are assembled to form a pattern which covers a substantially square area, wherein the individual molded elements (1) are formed as polygonal squares, rectangles and/or polygons and are coupled to one another to form a composite plate (8) by means of a woven reinforcing fabric (9) arranged in a form-fitting, force-fitting and/or integral manner on the rear side of the molded elements (1) in such a manner that the individual molded elements (1) are arranged spaced apart from one another, wherein outer edges (10) of the composite plate (8) are formed so as to correspond to one another in such a manner that composite plates (8) with different patterns can be arranged in a variable arrangement in relation to one another.

11. The method as claimed in claim 2,
characterized in that the photoluminescent and/or noctilucent particles (6) are introduced into the base layer (3) in a uniform distribution, concentrated at points, in the form of characters, letters and/or numbers.

12. The method as claimed in claim 3,
characterized in that the photoluminescent and/or noctilucent particles (6) are introduced into the base layer (3) in a uniform distribution, concentrated at points, in the form of characters, letters and/or numbers.

13. The method as claimed in claim 4,
characterized in that the photoluminescent and/or noctilucent particles (6) are introduced into the base layer (3) in a uniform distribution, concentrated at points, in the form of characters, letters and/or numbers.

14. The method as claimed in claim 5,
characterized in that the photoluminescent and/or noctilucent particles (6) are introduced into the base layer (3) in a uniform distribution, concentrated at points, in the form of characters, letters and/or numbers.

15. The method as claimed in claim 6,
characterized in that the photoluminescent and/or noctilucent particles (6) are introduced into the base layer (3) in a uniform distribution, concentrated at points, in the form of characters, letters and/or numbers.

16. The method as claimed in claim 2,
characterized in that glass fragments, rock fragments and/or colored or dyed sand or sand mixtures are introduced into the base layer (3) as further particles (7).

17. The method as claimed in claim 3,
characterized in that glass fragments, rock fragments and/or colored or dyed sand or sand mixtures are introduced into the base layer (3) as further particles (7).

18. The method as claimed in claim 4,
characterized in that glass fragments, rock fragments and/or colored or dyed sand or sand mixtures are introduced into the base layer (3) as further particles (7).

19. The method as claimed in claim 5,
characterized in that glass fragments, rock fragments and/or colored or dyed sand or sand mixtures are introduced into the base layer (3) as further particles (7).

20. The method as claimed in claim 6,
characterized in that glass fragments, rock fragments and/or colored or dyed sand or sand mixtures are introduced into the base layer (3) as further particles (7).
